(19) United States
(12) Patent Application Publication
(10) Pub. No.: US 2026/0025463 A1
(43) Pub. Date: Jan. 22, 2026

(54) SYSTEM AND METHOD TO RECONNECT COMMUNICATION TO THE SAME QUEUE AND PROVIDE QUEUE STATUS ON A DIFFERENT CHANNEL

(71) Applicant: Avaya Management L.P., Morristown, NJ (US)

(72) Inventors: Vigneshwar Gupta, Jammu (IN); Nilesh Shinde, Pune (IN); Kiran Barhate, Pune (IN)

(21) Appl. No.: 18/777,536

(22) Filed: Jul. 18, 2024

(51) Int. Cl. H04M 3/523; H04M 3/493

(52) U.S. Cl. CPC H04M 3/523; H04M 3/493

(57) ABSTRACT

A system, device, and method to reconnect a terminated communication to the original queue and provide queue status over a different communication channel. The method includes receiving a first communication over a first communication channel and placing the first communication in a contact center queue. The method also includes providing a user with an option to terminate the first communication over the first communication channel and receive queue status information over a second communication channel, and in response to the user selecting the option: terminating the first communication while maintaining a queue status in the contact center queue for the first communication; providing the queue status information; in response to the queue status of the first communication being within a threshold, notifying the user to initiate a second communication over the first communication channel; and replacing the first communication in the contact center queue with the second communication.

### FIELD

The disclosure relates generally to contact centers and particularly to queue management in a contact center.

### BACKGROUND

When customers call into a contact center, the customers typically answer questions by interacting with Interactive Voice Response (IVR) systems. Based on how the customers respond, the customers then get placed on hold in one or more contact center queues while waiting for contact center agents to become available. The customers have to wait on the call until it is their turn. If there is a long queue, the customer may be on hold for a long time before their call is answered.

### SUMMARY

These and other needs are addressed by the various embodiments and configurations of the present disclosure. In embodiments, User A contacts a contact center. The contact may be a voice call, a video call, instant message, email, etc. User A is placed in a queue until a contact center agent becomes available. For example, an Interactive Voice Response (IVR) system may direct User A's contact to the appropriate queue. While User A is waiting, the system provides User A with the option to terminate the communication, while maintaining their position in the queue, and receive notification(s) regarding their queue status over a different communication channel.

Additionally, when User A is offered the option to terminate the communication, maintain their position in the queue, and receive notification(s) regarding their queue status over a different communication channel, User A may be informed of their current position (e.g., position 10 means there are nine calls ahead of User A) and/or of an estimated wait time. For example, if User A contacts the contact center via a voice call (e.g., a first channel), User A may receive status notifications/updates via text (e.g., a second channel). In other words, instead of waiting on hold, User A may hangup and be notified when to call back. User A may be notified to call back when they are in or above a certain position (e.g., first, second, third, etc.) in the queue. When User A calls back, their position in the queue is maintained from the previous communication that was terminated, and the new communication is placed in the current position in the queue as if the original communication was not terminated.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112 (f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

As described herein and in the claims, the term “contact center queue” may be any computer construct where a voice or video communication session is placed on hold. For example, the contact center queue may be a first-in-first out contact center queue, a contact center pool (i.e., where agents select a voice or video call from the contact center pool), and/or the like.

As described herein and in the claims, the term “entity” can be or may include any type of entity, such as, an organization, an enterprise, a corporation, a business, a partnership, an individual person, and/or the like.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 is a block diagram of a first illustrative system for reconnecting a communication to a queue and providing queue status over a different channel according to at least one embodiment of the present disclosure;

FIG. 2 is a block diagram of a contact center queue according to at least one embodiment of the present disclosure; and

FIG. 3 is a flow diagram of a process for reconnecting a communication to a queue and providing queue status over a different channel according to at least one embodiment of the present disclosure.

### DETAILED DESCRIPTION

During interaction with a contact center, if there is long waiting queue, then provide the user an option to switch over to another channel for notification of queue status.

Example aspects of the present disclosure include: a system including a microprocessor and a computer readable medium, coupled with the microprocessor and comprising microprocessor readable and executable instructions that, when executed by the microprocessor, cause the microprocessor to: receive, via a network, a first communication over a first communication channel, wherein the first communication is placed on hold in a contact center queue; provide, via the network, a user associated with the first communication an option to terminate the first communication over the first communication channel and receive queue status information over a second communication channel; and in response to the user selecting the option: terminate the first communication while maintaining a queue status in the contact center queue for the first communication; provide, via the network, the queue status information; in response to the queue status of the first communication being within a threshold, notify the user to initiate a second communication over the first communication channel; and replace the first communication in the contact center queue with the second communication.

In another illustrative example includes a method including receiving a first communication over a first communication channel, wherein the first communication is placed on hold in a contact center queue; providing a user associated with the first communication an option to terminate the first communication over the first communication channel and receive queue status information over a second communication channel; and in response to the user selecting the option: terminating the first communication while maintaining a queue status in the contact center queue for the first communication; providing the queue status information; in response to the queue status of the first communication being within a threshold, notifying the user to initiate a second communication over the first communication channel; and replacing the first communication in the contact center queue with the second communication.

In yet another illustrative example, a contact center including a microprocessor; and a computer readable medium, coupled with the microprocessor and comprising microprocessor readable and executable instructions that, when executed by the microprocessor, cause the microprocessor to: receive, via a network, a first communication over a first communication channel, wherein the first communication is placed on hold in a contact center queue; provide, via the network, a user associated with the first communication an option to terminate the first communication over the first communication channel and receive queue status information over a second communication channel; and in response to the user selecting the option: terminate the first communication while maintaining a queue status in the contact center queue for the first communication; provide, via the network, the queue status information; in response to the queue status of the first communication being within a threshold, notify the user to initiate a second communication over the first communication channel; and replace the first communication in the contact center queue with the second communication.

The above example aspect includes wherein the first communication channel comprises a voice channel.

The above example aspect includes wherein the second communication channel comprises a text channel.

The above example aspect includes wherein the queue status information comprises an estimated wait time and a queue position.

The above example aspect includes wherein the queue status comprises a position in the contact center queue, and wherein the first communication being within the threshold comprises the first communication being next in the contact center queue.

The above example aspect further comprises notifying the user of an estimated wait time.

The above example aspect further comprises notifying the user of a current queue position.

The above example aspect further comprises routing the first communication to the contact center queue using an Interactive Voice Response (IVR) system.

The above example aspect further comprises the user selecting a type of the second communication channel to receive queue status information.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

It is to be appreciated that any feature described herein can be claimed in combination with any other feature(s) as described herein, regardless of whether the features come from the same described embodiment.

The details of one or more aspects of the disclosure are set forth in the accompanying drawings and the description below. Other features, objects, and advantages of the techniques described in this disclosure will be apparent from the description and drawings, and from the claims.

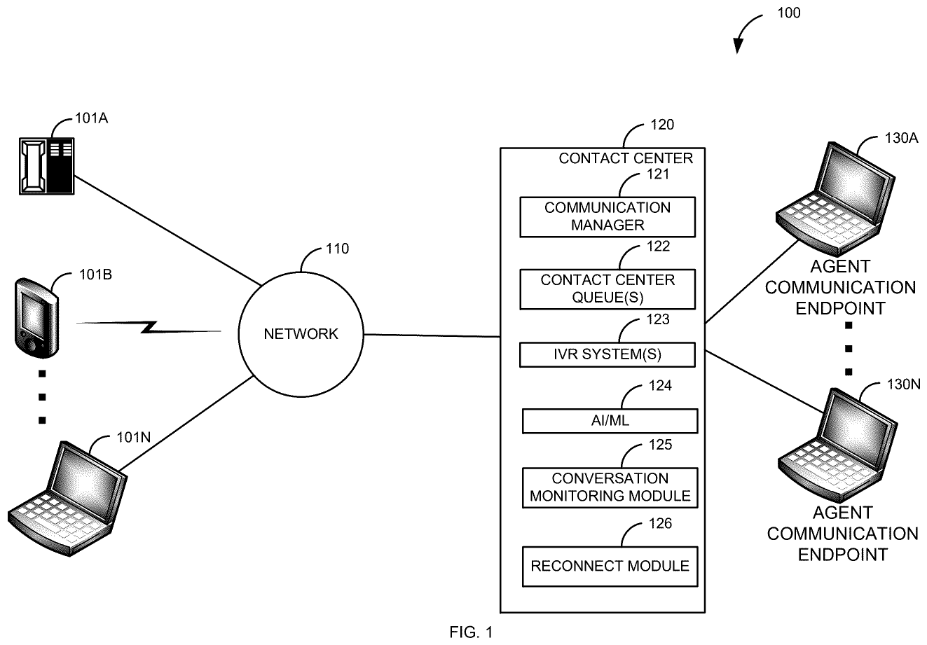

FIG. 1 is a block diagram of a first illustrative system 100 for reconnecting a communication to a queue and providing queue status over a different channel. The first illustrative system 100 comprises customer communication endpoints 101A-101N, a network 110, a contact center 120, agent communication endpoints 130A-130N, servers 140A-140N, and entity systems 150A-150N.

The customer communication endpoints 101A-101N can be or may include any user communication endpoint device that can communicate on the network 110, such as a Personal Computer (PC), a telephone, a video system, a cellular telephone, a Personal Digital Assistant (PDA), a tablet device, a notebook device, a smartphone, a laptop computer, and/or the like. The customer communication endpoints 101A-101N are devices where a communication session terminates. The customer communication endpoints 101A-101N are not network elements that facilitate and/or relay a communication session in the network 110, such as a communication manager 121 or router. As shown in FIG. 1, any number of customer communication endpoints 101A-101N may be connected to the network 110.

The network 110 can be or may include any collection of communication equipment that can send and receive electronic communications, such as the Internet, a Wide Area Network (WAN), a Local Area Network (LAN), a Voice over IP Network (VOIP), the Public Switched Telephone Network (PSTN), a packet switched network, a circuit switched network, a cellular network, a combination of these, and/or the like. The network 110 can use a variety of electronic protocols, such as Ethernet, Internet Protocol (IP), Session Initiation Protocol (SIP), Integrated Services Digital Network (ISDN), H.323, Web Real-Time Communication (WebRTC) protocol, video protocols, email protocols, text messaging protocols, Instant Messaging (IM) protocols, and/or the like. Thus, the network 110 is an electronic communication network configured to carry messages via packets and/or circuit switched communications.

The contact center 120 can be or may include any hardware coupled with software that can route communication sessions between the customer communication endpoints 101A-101N and the agent communication terminals 130A-130N. The contact center 120 further comprises a communication manager 121, contact center queue(s) 122, Interactive Voice Response (IVR) system(s) 123, an Artificial Intelligent (AI)/Machine Learning (ML) module 124, conversation monitoring module 125, and reconnect module 126.

The communication manager 121 can be or may include any hardware coupled with software that can manage and route communications in the contact center 120, such as a Private Branch Exchange (PBX), a proxy server, a session manager, an Instant Messaging (IM) server, a text messaging server, a video router, a conference bridge, and/or the like.

The contact center queue(s) 122 can be or may include any computer construct that holds a communication session until it can be processed by a contact center agent. The contact center queue(s) 122 can hold voice communication sessions, video communication sessions, IM communication sessions, text messages, emails, and/or the like. The contact center queue(s) 122 may individually support different products or services provided by the contact center 120.

The Interactive Voice Response (IVR) system(s) 123 can be or may include any hardware coupled with software that can verbally and/or visually interact with a user in a voice or video communication session. The IVR system(s) 123 typically provides a series of menus that allow a voice or video communication session (e.g., a voice call) to be routed to a specific contact center queue 122 and/or contact center agent.

Artificial Intelligence and/or machine learning module 124 can be or may include any hardware coupled with software that can predict the time to dial back/reconnect to the contact center. For example, the AI/ML module 124 may use output from a conversation monitoring module 125 that monitors each agent's conversation to determine whether the conversation is just started, in process, nearing termination, etc. Additionally, the AI/ML module 124 may determine an estimated time based on queue volume. Using the determined estimated time, a reconnect module 126 notifies the customer when to dial back to continue further interaction over phone call. When the customer calls back from the same number, the reconnect module 126 places the reconnected call in the same queue as the previous communication. Optionally, the reconnect module 126 may provide the customer a code that allows the customer to continue the same interaction though different phone number. The conversation monitoring module 125 and the reconnect module 126 can be or may include any hardware coupled with software that performs the methods described herein.

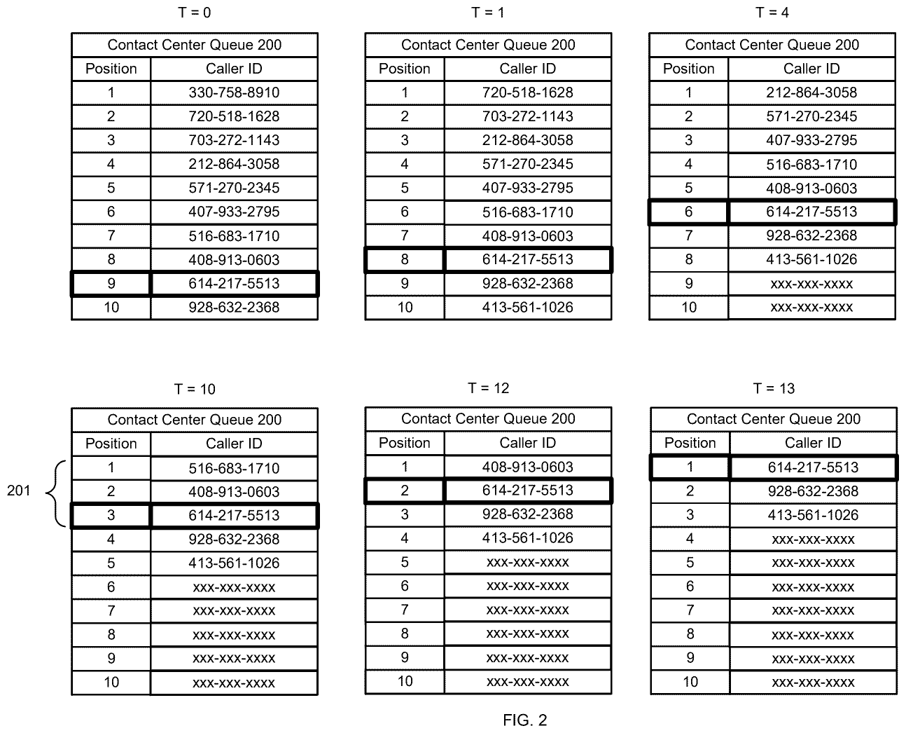

FIG. 2 is a block diagram showing a contact center queue 200 over a time period T=0 minutes to T=13 minutes. As illustrated in FIG. 2, a T=0, a user contacts a contact center via the phone number 614-217-5513, the user is in queue position 9 and there are eight calls ahead of the user. After the user is placed in the contact center queue 200, the user may be presented with the option to terminate the communication, while maintaining their position in the queue, and receive notification(s) regarding their queue status over a different communication channel.

Sometime between T=0 and T=1 the user accepts the option to terminate the communication, while maintaining their position in the queue, and receive notification(s) regarding their queue status over a different communication channel. Although the communication has been terminated, the user maintains their position in the contact center queue 200, at T=1, the user has moved up to position 8. At T=5, the user has moved up to position 6. At T=10 the user is in position 3, which is within a threshold 201. In response to the user being within the threshold position 201, the user is notified over the second communication channel to call back. The threshold position 201 may be any predetermined position in the contact center queue. In one example, the user may call back when they are in position 2. When the call is reconnected, the system places the new call in position 2. In embodiments, the system may store a number associated with the communication and when another communication is received from the same number, the system identifies it is the user trying to reconnect, and places the call into the original queue at the current queue position.

In another embodiment, the user may wish to reconnect using a different number, the user may request a code, link, or other method to reconnect using a different number. The user may reconnect anytime after T-10. In embodiments, the user's queue position is maintained for a predetermined amount of time, and if the user does not reconnect within the predetermined amount of time, the user is removed from the contact center queue 200. In some embodiments, before removing the suer from the contact center queue 200, the system may give the user the option to maintain their position for another predetermined amount of time (e.g., the system sends the option to the user to maintain their queue position for another 2 minutes to allow the user time to call back).

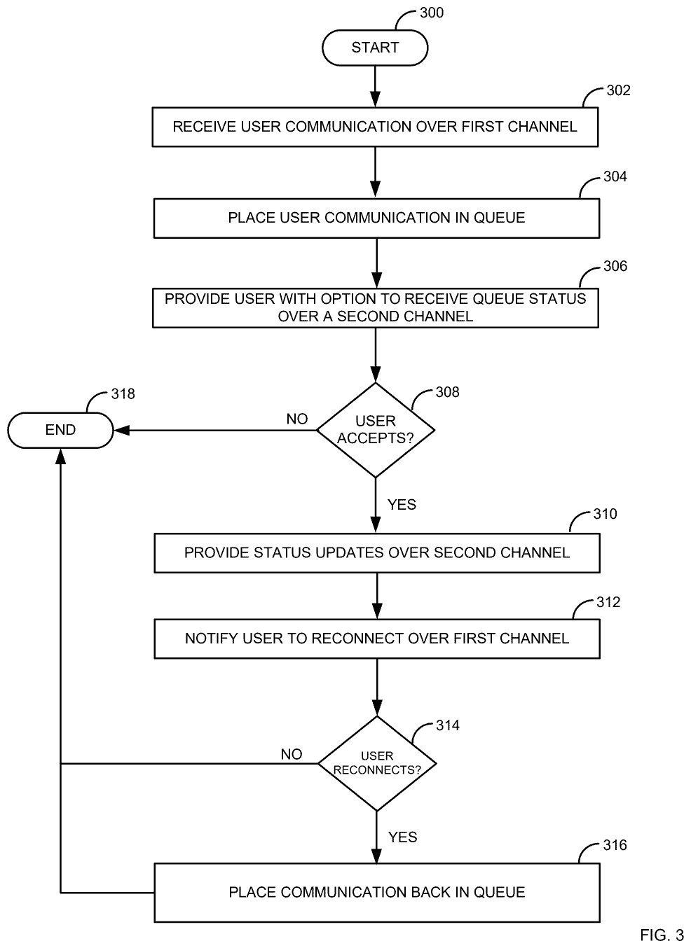

FIG. 3 is a flow diagram of a process 300 for maintain a queue position for a terminated communication, providing queue status over a different channel, and reconnecting the terminated communication to the queue. Illustratively, the customer communication endpoints 101A-101N, the contact center 120, the communication manager 121, the contact center queue(s) 122, the IVR system(s) 123, the Ai/ML module 124, the conversation monitoring module 125, the reconnect module 126, the agent communication endpoints 130A-130N are stored-program-controlled entities, such as a computer or microprocessor, which performs the method of FIG. 3 and the processes described herein by executing program instructions stored in a computer readable storage medium, such as a memory (i.e., a computer memory, a hard disk, and/or the like). Although the method described in FIG. 3 is shown in a specific order, one skilled in the art would recognize that the steps in FIG. 3 may be implemented in different orders and/or be implemented in a multi-threaded environment. Moreover, various steps may be omitted or added based on implementation.

The process of FIG. 3 starts in step 300. In step 302, a user communication is received over a first channel. For example, a user places a voice call to the contact center 120 via user device 101B. The first communication may be routed using the IVR system 123 to a contact center queue 122 (step 304). While the communication is in the contact center queue 122, the user associated with the communication is provided an option to terminate the first communication over the first channel (e.g., the voice call) and receive queue status information over a second communication channel (step 306). If the user does not accept (NO), the process 300 ends.

If in step 308, the user accepts the option (YES), the process 300 proceeds to step 310 where the user is provided with queue status notifications over a second communication channel. For example, the user may receive text notifications to the device 101B. After a predetermined amount of time, or when the user is within a given threshold position, the user will be notified to reconnect over the first channel (step 312). For example, AI/ML module 124 may determine an average wait time for the user and the system can notify the user to call back when they are within a threshold time remaining of the determine wait time. Said another way, if the AI/ML module 124 determines the wait time for the user is 15 minutes, the system may notify the user to call back after 13 minutes have passed, leaving 2 minutes of waiting time for the user to call back in and be reconnected. In another example, the system monitors the user's position in the queue and notifies the user to call back when they are within a certain position in the queue (e.g., position 3 or above). If the user does not reconnect (NO), the process 300 ends (step 318).

If the user reconnects (YES) in step 314, the reconnected communication is placed back in the queue (step 316). For example, the first communication in the contact center queue 200 is replaced with the second communication, which may or may not be from the same number.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those skilled in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving case and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
receive, via a network, a first communication over a first communication channel, wherein the first communication is placed on hold in a contact center queue;
provide, via the network, a user associated with the first communication an option to terminate the first communication over the first communication channel and receive queue status information over a second communication channel; and
in response to the user selecting the option:
terminate the first communication while maintaining a queue status in the contact center queue for the first communication;
provide, via the network, the queue status information;
in response to the queue status of the first communication being within a threshold, notify the user to initiate a second communication over the first communication channel; and
replace the first communication in the contact center queue with the second communication.

2. The system of claim 1, wherein the first communication channel comprises a voice channel.

3. The system of claim 1, wherein the second communication channel comprises a text channel.

4. The system of claim 1, wherein the queue status information comprises an estimated wait time and a queue position.

5. The system of claim 1, wherein the queue status comprises a position in the contact center queue, and wherein the first communication being within the threshold comprises the first communication being next in the contact center queue.

6. The system of claim 1, further comprising:
notifying the user of an estimated wait time.

7. The system of claim 1, further comprising:
notifying the user of a current queue position.

8. The system of claim 1, further comprising:
routing the first communication to the contact center queue using an Interactive Voice Response (IVR) system.

9. The system of claim 1, further comprising:
the user selecting a type of the second communication channel to receive queue status information.

10. A method comprising:
receiving a first communication over a first communication channel, wherein the first communication is placed on hold in a contact center queue;
providing a user associated with the first communication an option to terminate the first communication over the first communication channel and receive queue status information over a second communication channel; and
in response to the user selecting the option:
terminating the first communication while maintaining a queue status in the contact center queue for the first communication;
providing the queue status information;
in response to the queue status of the first communication being within a threshold, notifying the user to initiate a second communication over the first communication channel; and
replacing the first communication in the contact center queue with the second communication.

11. The method of claim 10, wherein the first communication channel comprises a voice channel.

12. The method of claim 10, wherein the second communication channel comprises a text channel.

13. The method of claim 10, wherein the queue status information comprises an estimated wait time and a queue position.

14. The method of claim 10, wherein the queue status comprises a position in the contact center queue, and wherein the first communication being within the threshold comprises the first communication being next in the contact center queue.

15. The method of claim 10, further comprising:
notifying the user of an estimated wait time.

16. The method of claim 10, further comprising:
notifying the user of a current queue position.

17. The method of claim 10, further comprising:
routing the first communication to the contact center queue using an Interactive Voice Response (IVR) system.

18. The method of claim 10, further comprising:
the user selecting a type of the second communication channel to receive queue status information.

19. A contact center comprising:
a microprocessor; and
a computer readable medium, coupled with the microprocessor and comprising microprocessor readable and executable instructions that, when executed by the microprocessor, cause the microprocessor to:
receive, via a network, a first communication over a first communication channel, wherein the first communication is placed on hold in a contact center queue;
provide, via the network, a user associated with the first communication an option to terminate the first communication over the first communication channel and receive queue status information over a second communication channel; and
in response to the user selecting the option:
terminate the first communication while maintaining a queue status in the contact center queue for the first communication;
provide, via the network, the queue status information;
in response to the queue status of the first communication being within a threshold, notify the user to initiate a second communication over the first communication channel; and
replace the first communication in the contact center queue with the second communication.

20. The contact center of claim 19, wherein the first communication channel comprises a voice channel, and wherein the user selects a type of the second communication channel.
